(19) United States
(12) Patent Application Publication
(10) Pub. No.: US 2014/0007473 A1
(43) Pub. Date: Jan. 9, 2014

(54) STORAGE BOX WITH A PLASTIC NAME TAG

(71) Applicant: Morten Røssell, Dyssegard (DK)

(72) Inventor: Morten Røssell, Dyssegard (DK)

(73) Assignee: PLAST TEAM A/S, Naerum (DK)

(21) Appl. No.: 13/984,575

(22) PCT Filed: Feb. 7, 2012
(86) PCT No.: PCT/DK12/00012

§ 371 Date: Sep. 18, 2013

(30) Foreign Application Priority Data
Feb. 9, 2011 (DK) BA 2011 000 33

(51) Int. Cl. B65D 25/00; G09F 3/02

(52) U.S. Cl. CPC B65D 25/00; G09F 3/02
USPC 40/312

(57) ABSTRACT

The invention disclose a product containing a storage box and a plastic name tag (1), wherein said storage box has a collar (3) with a cut/groove (2) for insertion of the plastic name tag (1), the plastic name tag (1) has a thickened cylindrical edge intended to abut the upper surface of the collar (3) of the storage box, thereby preventing the name tag (1) to fall out of the storage box.

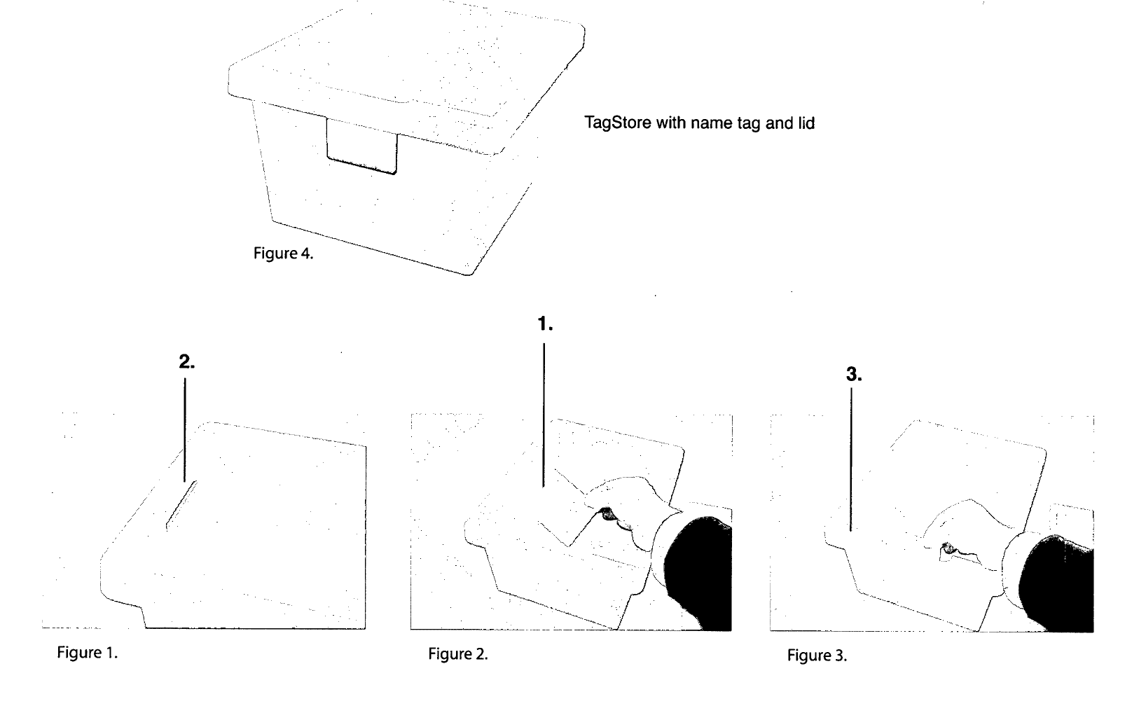

This invention contains a storage box (FIG. 3, reference description no. 3), were the collar (FIG. 1, reference description no. 2) contains a groove/cut, in which the associated plastic name tag (FIG. 5) can be inserted (FIG. 2, reference description no. 1).

Previously, stickers, post-its and other kind of identification were used, when there was no possibility just to replace and change the identification during usage. Alternatively, you wrote directly on the box, which was inappropriate, if the contents of the box were changed, or the box was to be used in another way than originally intended.

The aim of the invention is to provide a solution in the prior known technical problem to name and identify boxes in a collected system.

Using plastic signs is an innovation within a systematisation and identification of boxes, as the signs easily can be switched, if needed including combining signs and boxes in various colours. If the contents of the box are to be changed, or the box is intended to be used in another way, previous problems and inconveniences are solved by using this box and the associated plastic tags.

For its illustration we enclose a drawing with information as follows:

FIG. 1: Storage box with cut/groove in its collar

FIG. 2: Name tag in plastic together with the storage box

FIG. 3: Name tag location in the cut/groove in the collar of the storage box

FIG. 4: Storage box with inserted name tag in plastic

FIG. 5: The name tag in plastic with a thickened cylindrical edge

The name tag is to be put into the cut/groove (FIG. 1, reference description no. 2) to be found in the collar on the storage box (FIG. 3, reference description no. 3). To prevent the name tag to fall out, it is furnished with a thickened cylindrical edge (FIG. 5), which after tag insertion in the cut/groove abuts the upper surface of the collar of the box. Thus the storage box and name tag together constitute a unique model (FIG. 4).

The name tag provides the storage box with a unique identity and opportunity for many system utilities.

The storage box is included in a storage range from size 0.5 L to 70 L including 1 pc. bed roller.

The name tag (FIG. 2, reference description no. 1) is interchangeable and available in various colours.

The name tag is a natural integrated part of the product.

The name tag is also reversible and thus has even more applications in relation to an identification/systematization of the product.

The tag is writable on both sides in ink, which can be removed and rewritten.

Furthermore, the name tag can be purchased in various colours, so the end user has the opportunity to create his own system as to a particular colour or colour combination.

1. (canceled)

2. A storage box comprising:
a sidewall having an upper box edge, said upper box edge being horizontal and having a collar extending downward, said collar being formed with a groove; and
a tag removably received within said groove, said tag being sized and shaped to extend from said groove downwardly so that said tag is visible on said sidewall.

3. The storage box of claim 2 wherein said tag has a flat body extending below said groove, said flat body having opposed surfaces.

4. The storage box of claim 2 wherein said tag includes a flat body having an upper tag edge and a retaining member for retaining said tag in said groove.

5. The storage box of claim 4 wherein said upper tag edge is cylindrical.

6. A storage box comprising:
a storage box body having at least one lateral sidewall formed with an upper box edge, said upper box edge being shaped to form a collar extending outwardly of said sidewall, said collar extending horizontally and having a horizontal cut; and
a tag having a tag body that has a flat geometric shape and an upper portion thicker than a width of the cut so that when said when said tag is inserted into said cut, said tag extends outwardly partially overlapping said sidewall, said tag being retained within said cut and supported on said collar by said upper portion.

7. The storage box of claim 6 wherein said tag is made of a plastic material.

8. The storage box of claim 6 wherein said tag body is generally rectangular with two opposed surfaces so that an identifying mark can be made on either surface.
